(19) United States
(12) Patent Application Publication
(10) Pub. No.: US 2017/0230296 A1
(43) Pub. Date: Aug. 10, 2017

(54) NETWORK TRAFFIC CONTROL DEVICE AND METHOD FOR CONTROLLING NETWORK TRAFFIC BASED ON PROFILE

(71) Applicant: Gurumnetworks, Inc., Yongin-si (KR)

(72) Inventor: Sung Min KIM, Yongin-si (KR)

(21) Appl. No.: 15/282,914

(22) Filed: Sep. 30, 2016

(30) Foreign Application Priority Data
Feb. 5, 2016 (KR) 10-2016-0015063

(51) Int. Cl. H04L 12/803; H04L 12/801; H04L 29/06; H04L 29/08

(52) U.S. Cl. CPC H04L 47/125; H04L 67/303; H04L 47/11; H04L 69/22

(57) ABSTRACT

A method for controlling network traffic based on a profile includes: allocating a bandwidth share to each of a plurality of network interface controllers; calculating an actually-allocated bandwidth based on the bandwidth share allocated to each of the network interface controllers and a bandwidth profile; and setting up the plurality of network interface controllers so that each of the network interface controllers operates with respective calculated, actually-allocated bandwidths. The maximum bandwidths available to the network interface controllers depending on packet sizes are profiled, so that different bandwidths are allocated for different packet sizes. As a result, network resources can be managed more precisely.

### CROSS-REFERENCE TO RELATED APPLICATIONS

This application claims the priority of Korean Patent Application No. 2016-0015063 filed on Feb. 5, 2016, in the Korean Intellectual Property Office, the disclosure of which is incorporated herein by reference.

### BACKGROUND

Technical Field

The present disclosure relates to a network traffic control device and a method for controlling network traffic based on a profile. More specifically, the present disclosure relates to a network traffic control device and a method for controlling network traffic based on a profile that can manage network resources more precisely by allocating different bandwidths for different packet sizes based on a maximum bandwidth profile.

Description of the Related Art

As network technology rapidly evolves, network bandwidths can be distributed across a plurality of clients so that they can access the network simultaneously.

Typically, when a plurality of clients uses a network simultaneously, network interface controllers each in the respective clients competitively utilize the maximum available network bandwidth.

### SUMMARY

In recent network virtualization technology, each of a plurality of network interface controllers may have an allocated portion of a bandwidth in order to prohibit one network interface controller from taking all of the bandwidth. By allocating a certain portion of the bandwidth to each of virtualized network interface controllers of virtual machines, it is possible to guarantee the availability of the bandwidth allocated among virtual machines.

In addition, the amounts of the maximum available bandwidths vary depending on packet sizes. Accordingly, if the bandwidth of a network is allocated without considering packet sizes, the amount of the bandwidth available to a network interface controller may be lower than the allocated bandwidth of the network interface controller. That is, the availability of the allocated bandwidth cannot be guaranteed if the bandwidth is allocated without considering packet sizes.

In view of the above, the inventors of the application have recognized that, in a network structure where NICs have their bandwidth allocations instead of competing for bandwidths, the allocated bandwidth can be utilized more efficiently by considering packet sizes.

In view of the above, an object of the present disclosure is to provide a network traffic control device and a method for controlling network traffic with improved precision and efficiency by allocating different bandwidths for different packet sizes based on the profile that indicates maximum bandwidths available to the network interface controllers depending on packet sizes.

Another object of the present disclosure is to provide a network traffic control device and a method for controlling network traffic capable of allocating bandwidths based on a profile by allocating a bandwidth in percentage instead of in bps.

It should be noted that objects of the present disclosure are not limited to the above-described objects, and other objects of the present disclosure will be apparent to those skilled in the art from the following descriptions.

According to an aspect of the present disclosure, there is provided a method for controlling network traffic based on a profile, the method including: allocating a bandwidth share to each of a plurality of network interface controllers; calculating an actually-allocated bandwidth based on the bandwidth share allocated to each of the network interface controllers and a bandwidth profile; and setting up the plurality of network interface controllers so that each of the network interface controllers operates with respective calculated, actually-allocated bandwidths.

The method may further include determining the bandwidth profile prior to the calculating.

The bandwidth profile may include packet sizes and maximum bandwidths in association with the packet sizes.

The plurality of network interface controllers may be a plurality of virtualized network interface controllers, and the allocating may include allocating a bandwidth available to a host of the plurality of virtualized network interface controllers in percentage.

The calculating may include determining a size of an incoming packet; determining a maximum bandwidth associated with the size of the packet; and calculating the actually-allocated bandwidth based on the determined maximum bandwidth and the allocated bandwidth proportion.

The bandwidth profile may be determined based on consecutive functions of packet size with respect to bandwidth.

According to another aspect of the present disclosure, there is provided a network traffic control device based on a profile, the device including: a bandwidth share determination unit configured to allocate a bandwidth share to each of a plurality of network interface controllers; an actually-allocated bandwidth calculator configured to calculate an actually-allocated bandwidth based on the bandwidth share allocated to each of the plurality of network interface controllers and a bandwidth profile; and an NIC controller configured to set up the plurality of network interface controllers so that each of the plurality of network interface controllers operates with the respective calculated, actually-allocated bandwidth.

The device may further include: a bandwidth profile determination unit configured to determine the bandwidth profile.

The bandwidth profile may include packet sizes and maximum bandwidths in association with the packet sizes.

The plurality of network interface controllers may be a plurality of virtualized network interface controllers, and the bandwidth share determination unit may allocate a bandwidth available to a host of the plurality of virtualized network interface controllers in percentage.

Particulars of the exemplary embodiments of the present disclosure will be described in the detail description with reference to the accompanying drawings.

As set forth above, according to an exemplary embodiment of the present disclosure, different bandwidths are allocated for different packet sizes based on the profile that indicates maximum bandwidths available to the network interface controllers depending on packet sizes, so that network traffic can be controlled more precisely and efficiently.

In addition, according to an exemplary embodiment of the present disclosure, bandwidths can be allocated based on a profile by allocating a bandwidth in percentage instead of in bps.

It should be noted that effects of the present disclosure are not limited to those described above and other effects of the present disclosure will be apparent to those skilled in the art from the following descriptions.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram for illustrating relationship between a traffic control device and a plurality of client devices based on a profile according to an exemplary embodiment of the present disclosure;

FIG. 2 is a block diagram of a traffic control device based on a profile according to an exemplary embodiment of the present disclosure;

FIG. 3 is a flowchart for illustrating a method for controlling network traffic based on a profile according to an exemplary embodiment of the present disclosure; and

FIG. 4A is a table profiling maximum bandwidths depending on packet sizes according to an exemplary embodiment of the present disclosure; and FIG. 4B is a table showing an example in which maximum bandwidths are allocated to a plurality of client devices in percentage.

### DETAILED DESCRIPTION OF THE PREFERRED EMBODIMENT

Advantages and features of the present disclosure and methods to achieve them will become apparent from the descriptions of exemplary embodiments hereinbelow with reference to the accompanying drawings. However, the present disclosure is not limited to exemplary embodiments disclosed herein but may be implemented in various different ways. The exemplary embodiments are provided for making the disclosure of the present disclosure thorough and for fully conveying the scope of the present disclosure to those skilled in the art. It is to be noted that the scope of the present disclosure is defined only by the claims.

Combinations of the blocks of the block diagrams and the steps of the flowchart maybe carried out by algorithms or computer program instructions in firmware, software or hardware. These algorithms or computer program instructions may be installed in a processor of general-purpose computers, special-purpose computers or other programmable digital signal processing device. Therefore, the instructions executed by the processor of the computers or other programmable data processing device create means for performing functions described in the blocks of the block diagrams or in the steps of the flowchart. These algorithms or computer program instructions may be stored in computer-usable or computer-readable memories which can assist the computers or other programmable data processing device in implementing functions in certain manners. Therefore, the instructions stored in the computer-usable or computer-readable memories may be used to produce articles containing instruction means for performing the functions described in the blocks of the block diagrams or in the steps of the flowchart. The computer program instructions may also be installed in computers or other programmable data processing device. Therefore, a sequence of operation steps may be performed on the computers or other programmable data processing device to produce computer-executable processes. The instructions operating the computers or other programmable data processing device may provide steps for performing the functions described in the blocks of the block diagrams or in the steps of the flowchart.

In addition, the blocks or the steps may represent portions of modules, segments or codes including one or more executable instructions for executing a specified logical function(s). In addition, in some alternative embodiments, it should be noted that the functions described associated with blocks or steps may be performed out of a specified sequence. For example, two successive blocks or steps may be performed substantially at once or may be sometimes performed in a reverse order depending on a corresponding function.

Like reference numerals denote like elements throughout the descriptions.

The drawings are not to scale and the relative dimensions of various elements in the drawings are depicted schematically and not necessarily to scale.

Features of various exemplary embodiments of the present disclosure may be combined partially or totally. As will be clearly appreciated by those skilled in the art, technically various interactions and operations are possible. Various exemplary embodiments can be practiced individually or in combination.

Hereinafter, exemplary embodiments of the present disclosure will be described in detail with reference to the accompanying drawings.

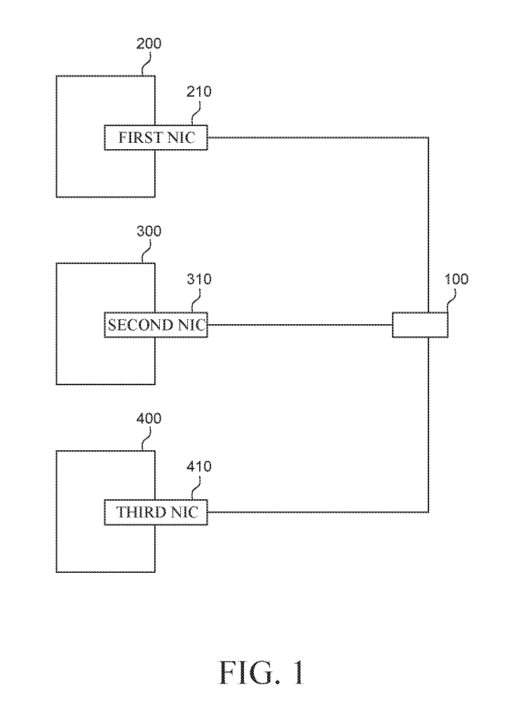

FIG. 1 is a diagram for illustrating relationship between a traffic control device and a plurality of client devices based on a profile according to an exemplary embodiment of the present disclosure. In the following description, it is assumed that there are one traffic control device 100 and three client devices 200, 300 and 400 based on a single profile for convenience of illustration. It is to be noted that the number of the traffic control device 100 and the number of the client devices 200, 300 and 400 based on the profile are not limited thereto.

Referring to FIG. 1, the traffic control device 100 allocates bandwidth shares to network interface controllers (NICs) 210, 310 and 410 of the plurality of client devices 200, 300 and 400, respectively, calculates actually-allocated bandwidths based on the bandwidth shares allocated to the network interface controllers and a bandwidth profile, and sets up the plurality of network interface controllers 210, 310 and 310 of the plurality of client devices 200, 300 and 400 so that they operate with their calculated, actually-allocated bandwidths

The client devices 200, 300 and 400 are devices for transmitting/receiving packets and may be a variety of electronic devices such as a server, a smartphone, a desktop computer, a laptop computer, a PC, etc. Alternatively, the client devices 200, 300 and 400 may be a plurality of virtual machines operating on a single host in a virtualized environment.

The NICs 210, 310 and 410 are network interface controllers included in the client devices 200, 300 and 400, respectively. Each of the NICs 210, 310 and 410 transmits/receives packets within the bandwidth allocated thereto. In addition, the NICs 210, 310 and 410 may be NICs virtualized in the virtual machines.

The traffic control device 100 shown in FIG. 1 allocates certain amounts of bandwidths to the NICs 210, 310 and 410, respectively, instead of setting up the NICs 210, 310 and 410 so that they compete for bandwidths. Accordingly, in the virtualized network, the NICs 210, 310 and 410 can operate in real-time.

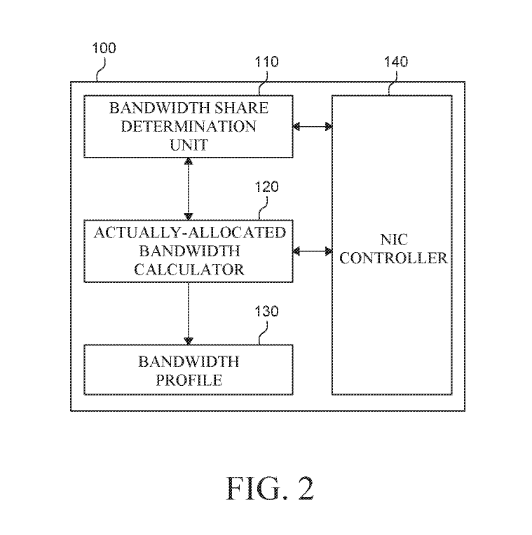

FIG. 2 is a block diagram of a traffic control device based on a profile according to an exemplary embodiment of the present disclosure.

Referring to FIG. 2, the traffic control device 100 includes a bandwidth share determination unit 110, an actually-allocated bandwidth calculator 120, a bandwidth profiler 130 and an NIC controller 140.

The bandwidth share determination unit 110 allocates a bandwidth share to each of the plurality of network interface controllers under the control of the NIC controller 140.

The actually-allocated bandwidth calculator 120 calculates actually allocated bandwidths based on the bandwidth shares allocated by the bandwidth share determination unit 110 to the network interface controllers and the bandwidth profile.

The bandwidth profile 130 may be a set of data indicative of the maximum available bandwidth for each of packets having different sizes. The bandwidth profile 130 may be in the form of a table. In some embodiments of the present disclosure, the bandwidth profile 130 may be in the form of consecutive functions. Alternatively, the bandwidth profile may be determined by an additional module based on the bandwidth shares allocated by the actually-allocated bandwidth calculator 12 to the network interface controllers and the bandwidth profile, before calculating the actually-allocated bandwidths.

The NIC controller 140 sets up the plurality of network interface controllers so that they operate with the actually-allocated bandwidths, respectively.

Hereinafter, a network traffic control device and a method for controlling network traffic based on a profile will be described in detail with reference to FIGS. 1 and 2.

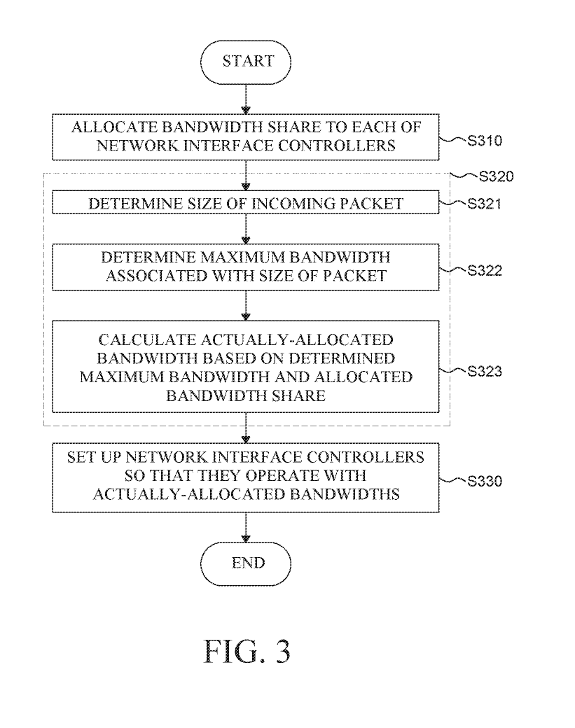

FIG. 3 is a flowchart for illustrating a method for controlling network traffic based on a profile according to an exemplary embodiment of the present disclosure. Hereinafter, descriptions will be made with reference to FIGS. 1 and 2 for convenience of illustration.

Referring to FIG. 3, the traffic control device 100 based on a profile allocates a bandwidth share to each of the plurality of NICs 210, 310 and 410 (step S310). Specifically, the bandwidth share determination unit 110 of the traffic control device 100 allocates a bandwidth share to each of the NICs 210, 310 and 410 of the first to nth network nodes, respectively, where n is a positive integer equal to or greater than two.

Subsequently, the traffic control device 100 calculates actually-allocated bandwidths based on the bandwidth shares allocated to the network interface controllers 210, 310 and 410 and a bandwidth profile (step S320).

Firstly, the traffic control device 100 determines the sizes of incoming packets (step S321). Specifically, the NIC controller 140 determines the sizes of packets from the client devices 200, 300 and 400 to the NICs 210, 310 and 410, respectively, or the sizes of packets from an external source.

Subsequently, the traffic control device 100 determines the maximum bandwidths depending on the sizes of the packets (step S322). Specifically, the bandwidth share determination unit 110 determines the maximum bandwidths depending on the sizes of the packets based on a predefined bandwidth profile. For example, when the size of an incoming packet is 64 bytes, the maximum available bandwidth in the network interface controllers 210, 310 and 410 may be predefined as 180 Mbps. At this time, the bandwidth share determination unit 110 may determine the maximum bandwidth for the network interface controllers 210, 310 and 410 as 180 Mbps when the size of the packet received by the NICs 210, 310 and 410 is 64 bytes.

As used herein, a bandwidth profile indicates maximum available bandwidths depending on the sizes of packets. For example, when the sizes of packets are 64, 128 and 256 bytes, the profile indicates that the maximum available bandwidth in the network interface controllers 210, 310 and 410 are 180, 300 and 500 Mbps, respectively. In addition, as described above, the packet sizes and the maximum available bandwidths in the bandwidth profile may not have fixed values but may be determined based on consecutive functions of packet sizes with respect to bandwidths.

Subsequently, the traffic control device 100 calculates actually-allocated bandwidths based on the determined maximum bandwidths and the allocated bandwidth shares (step S323). For example, suppose that the bandwidth profile defines the maximum available bandwidth as 900 Mbps for a packet having the size of 1,024 bytes, that the client devices 200, 300 and 400 are connected to the NICs 210, 310 and 410, respectively, and that the shares of the bandwidths allocated to the client devices 200, 300 and 400 are 50, 30 and 20 percentages, respectively.

In this example, when the packet size received by the NICs 210, 310 and 410 is 1,024 bytes, the actually-allocated bandwidth calculator 120 may allocate the bandwidths of 450, 270 and 180 Mbps to the client devices 200, 300 and 400, respectively.

Subsequently, the traffic control device 100 sets up the plurality of NICs 210, 310 and 410 so that they operate with their actually-allocated bandwidths (step S330).

According to an exemplary embodiment of the present disclosure, the traffic control device 100 allocates different bandwidths for different packet sizes based on the profile that indicates maximum bandwidths that can be received by the network interface controllers depending on the sizes of packets. As a result, the network traffic can be controlled more precisely and efficiently.

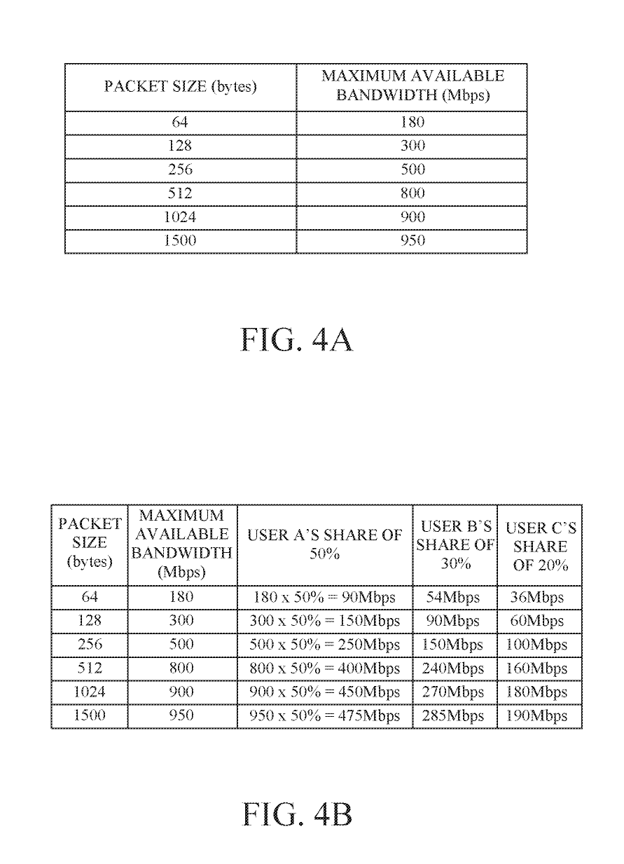

FIG. 4A is a table profiling maximum bandwidths depending on packet sizes according to an exemplary embodiment of the present disclosure. FIG. 4B is a table showing an example in which maximum bandwidths are allocated to a plurality of client devices in percentage. Descriptions will be made with reference to FIGS. 1 and 2 for convenience of illustration.

Referring to FIG. 4A, the NICs 210, 310 and 410 connected to the traffic control device 100 stores a predefined network bandwidth profile therein.

The network bandwidth profile indicates maximum available bandwidths depending on packet sizes. For example, for the packet sizes of 64, 128, 256, 512, 1024 and 1500 bytes, the maximum available bandwidth in the network interface controllers 210, 310 and 410 are 180, 300, 500, 800, 900 and 950 Mbps, respectively.

The network bandwidth profile may be defined in a predetermined manner or may be newly defined with updated content at predetermined time intervals. In addition, each of the NICs 210, 310 and 410 may store their own network bandwidth profiles therein or the NICs 210, 310 and 410 may store a common bandwidth profile.

Referring to FIG. 4B, the traffic control device 100 allocates the maximum bandwidths to the plurality of client devices 200, 300 and 400 in percentage. For example, suppose that the first to third client devices 200, 300 and 400 (users A, B and C) are connected to the NICs 210, 310 and 410, respectively, and that the shares of the bandwidths allocated to the client devices 200, 300 and 400 are 50, 30 and 20 percentages, respectively.

In this example, when the size of the packet is 64 bytes, the actually-allocated bandwidth calculator 120 multiplies the allocated bandwidth in percentage by the maximum available bandwidth for the packet size based on the predefined bandwidth profile. Accordingly, the bandwidths of 90, 54 and 36 Mbps may be allocated to the first to third client devices 200, 300 and 400, respectively, such that it is possible to save the bandwidths from being wasted.

For another example, when the packet size is 512 bytes, the actually-allocated bandwidth calculator 120 may allocate the bandwidths of 400, 240 and 160 Mbps to the first to third client devices 200, 300 and 400, respectively, based on the predefined bandwidth profile.

In addition, according to an exemplary embodiment of the present disclosure, the traffic control device 100 allocates the bandwidths in percentage instead of in bps, such that a client cannot take another client's bandwidth. As a result, all of the client devices can share the bandwidths fairly.

Herein, the blocks or the steps may represent portions of modules, segments or codes including one or more executable instructions for performing specific logical function(s). In addition, it should be noted that, in some alternative embodiments, the functions described in association with blocks or steps may be performed out of a specified sequence. For example, two consecutive blocks or steps may be performed substantially simultaneously or may be performed in the reverse order depending on the function to be performed.

The steps of the method or the algorithm described with respect to the exemplary embodiments of the present disclosure may be implemented in hardware or as a software module executed by a processor, or as a combination thereof. The software module may reside on a RAM memory, a flash memory, a ROM memory, an EPROM memory, an EEPROM memory, a register, a hard disk, a removable disk, a CD-ROM or any storage medium known in the art. An example storage medium may be coupled with a processor, and the processor may read/write information out of/onto the storage medium. Alternatively, the storage medium may be integrated with the processor. The processor and the storage medium may reside in an application-specific integrated circuit (ASIC). The ASIC may reside in a user terminal as well. Alternatively, the processor and the storage medium may reside in a user terminal as separate components.

Thus far, exemplary embodiments of the present disclosure have been described in detail with reference to the accompanying drawings. However, the present disclosure is not limited to the exemplary embodiments, and modifications and variations can be made thereto without departing from the technical idea of the present disclosure. Accordingly, the exemplary embodiments described herein are merely illustrative and are not intended to limit the scope of the present disclosure. The technical idea of the present disclosure is not limited by the exemplary embodiments. Therefore, it should be understood that the above-described embodiments are not limiting but illustrative in all aspects. The scope of protection sought by the present disclosure is defined by the appended claims and all equivalents thereof are construed to be within the true scope of the present disclosure.

What is claimed is:

1. A method for controlling network traffic based on a profile, the method comprising:
allocating a bandwidth share to each of a plurality of network interface controllers;
calculating an actually-allocated bandwidth based on the bandwidth share allocated to each of the network interface controllers and a bandwidth profile; and
setting up the plurality of network interface controllers so that each of the plurality of network interface controllers operates with their respective calculated, actually-allocated bandwidths.

2. The method of claim 1, further comprising:
determining the bandwidth profile prior to the calculating.

3. The method of claim 1, wherein the bandwidth profile comprises packet sizes and maximum bandwidths in association with the packet sizes.

4. The method of claim 3, wherein the plurality of network interface controllers is a plurality of virtualized network interface controllers, and
wherein the allocating comprises allocating a bandwidth available to a host of the plurality of virtualized network interface controllers in percentage.

5. The method of claim 3, wherein the calculating comprises:
determining a size of an incoming packet;
determining a maximum bandwidth associated with the size of the packet; and
calculating the actually-allocated bandwidth based on the determined maximum bandwidth and the allocated bandwidth share.

6. The method of claim 2, wherein the bandwidth profile is determined based on consecutive functions of packet size with respect to bandwidth.

7. A network traffic control device based on a profile, the device comprising:
a bandwidth share determination unit configured to allocate a bandwidth share to each of a plurality of network interface controllers;
an actually-allocated bandwidth calculator configured to calculate an actually-allocated bandwidth based on the bandwidth share allocated to each of the plurality of network interface controllers and a bandwidth profile; and
an NIC controller configured to set up the plurality of network interface controllers so that they operate with the respective calculated, actually-allocated bandwidths.

8. The device of claim 7, further comprising:
a bandwidth profile determination unit configured to determine the bandwidth profile.

9. The device of claim 7, wherein the bandwidth profile comprises packet sizes and maximum bandwidths in association with the packet sizes.

10. The device of claim 9, wherein the plurality of network interface controllers is a plurality of virtualized network interface controllers, and
wherein the bandwidth share determination unit allocates a bandwidth available to a host of the plurality of virtualized network interface controllers in percentage.
